(19) United States
(12) Patent Application Publication
(10) Pub. No.: US 2025/0075047 A1
(43) Pub. Date: Mar. 6, 2025

(54) HARD COATING FILM

(71) Applicant: NIPPON PAPER INDUSTRIES CO., LTD., Tokyo (JP)

(72) Inventors: Shotaro TOYA, Tokyo (JP); Shin SAITO, Tokyo (JP); Masahide HASEGAWA, Tokyo (JP)

(73) Assignee: NIPPON PAPER INDUSTRIES CO., LTD., Tokyo (JP)

(21) Appl. No.: 18/284,747

(22) PCT Filed: Mar. 29, 2022
(86) PCT No.: PCT/JP2022/015655

§ 371 Date: Sep. 28, 2023

(30) Foreign Application Priority Data
Mar. 30, 2021 (JP) 2021-058831

(51) Int. Cl. C08J 7/046; B32B 27/08; B32B 27/30; B32B 27/36; G02B 1/14

(52) U.S. Cl. CPC C08J 7/046; B32B 27/08; B32B 27/30; B32B 27/36; G02B 1/14; B32B 2250/02; B32B 2250/24; B32B 2255/10; B32B 2307/538; B32B 2307/732; B32B 2310/08; B32B 2333/00; B32B 2367/00; B32B 2457/202; B32B 2457/204; C08J 2333/08

(57) ABSTRACT

The present invention provides a hard coating film having excellent optical characteristics and adhesion of a hard coating layer, and having excellent adhesion to a laminated film formed on the hard coating film.

The hard coating film comprises a hard coating layer containing an ionizing radiation curable resin composition provided on at least one surface of a base film, the hard coating film satisfying the following conditions (I), (II), and (III):
condition (I): the ionizing radiation curable resin composition comprising an acrylic resin containing a (meth)acryloyl group;
condition (II): a peak area ratio 1 ((A/B)×100) of 5% or more (provided that in infrared spectrum measurement of the ionizing radiation curable resin composition in an uncured state, a peak area appearing at 3250 to 3500 cm⁻¹ is defined as A, and a peak area appearing at 1650 to 1800 cm⁻¹ is defined as B); and
condition (III): a peak area ratio 2 ((C/B)×100) of 30% or less (provided that in infrared spectrum measurement of the ionizing radiation curable resin composition in an uncured state, a peak area appearing at 1500 to 1580 cm⁻¹ is defined as C, and a peak area appearing at 1650 to 1800 cm⁻¹ is defined as B).

### TECHNICAL FIELD

The present invention relates to a hard coating film, and more specifically relates to a hard coating film provided with a hard coating layer that can be used as a component for flat panel displays and touch panels, such as liquid crystal display devices, plasma display devices, and electroluminescence (EL) display devices, and as a base film for carrier films, flexible substrates, and the like.

### BACKGROUND ART

Display surfaces of flat panel displays, such as liquid crystal display (LCD) devices, are required to have scratch resistance so that the surfaces are not damaged during handling to reduce the visibility. Therefore, it is common practice to impart scratch resistance using hard coating films obtained by providing hard coating layers on base films. In recent years, with the spread of touch panels that allow data and instructions to be input by touching with a finger, a pen, or the like while viewing the display on the display screen, functional requirements for hard coating films maintaining optical visibility and having scratch resistance are further increasing.

In recent years, the needs for base films for carrier films, flexible substrates, and the like have become more complicated, and materials and technologies to realize new electronics have been required. There is an increasing demand for films having excellent heat resistance (dimensional stability) against heat and adhesion to laminated films formed thereon. Accordingly, high-performance films are required which are obtained by providing hard coating layers (functional layers) on various base films to impart performance that cannot be obtained with base films alone, and which can meet the demand for even higher performance.

Therefore, as base films, polyethylene terephthalate, polyethylene naphthalate, triacetyl cellulose, and cycloolefin, which have excellent transparency, heat resistance, dimensional stability, and low hygroscopicity, and polyimide and liquid crystal polymers, which further have excellent dimensional stability, are expected to be used for optical and electronic components. A hard coating film obtained by further providing a hard coating layer for imparting hardness on such a base film is required to have not only excellent adhesion between the base film and the hard coating layer, but also excellent optical characteristics, heat resistance, and adhesion to a laminated film, with the diversification of applications in recent years.

Conventionally, for example, PTL 1, PTL 2, and the like disclose methods for imparting, to base films such as cycloolefin films particularly having excellent optical characteristics, easy adhesion to hard coating layers. PTL 1 discloses a method of performing corona treatment, plasma treatment, UV treatment, or the like on the base film surface, and PTL 2 discloses applying an anchor coating agent to a base film (anchor coating treatment).

### CITATION LIST

### Patent Literature

PTL 1: JP2001-147304A
PTL 2: JP2006-110875A

### SUMMARY OF INVENTION

### Technical Problem

However, it is desired that the adhesion between the base film and the hard coating layer can be improved without performing surface treatment of the base film or anchor coating treatment for imparting easy adhesion to the hard coating layer.

Moreover, depending on the application of the hard coating film, it has recently been required to provide a laminated film (e.g., a conductive film, a metal film, or a metal oxide film) on the surface of the hard coating layer. For example, a metal film of Cu etc. is formed on the hard coating film by a sputtering method or the like. For such applications, the hard coating film is also required to have adhesion to the laminated film formed by a sputtering method or the like.

Accordingly, an object of the present invention is to provide a hard coating film having excellent optical characteristics and adhesion of a hard coating layer, and further having adhesion to a laminated film formed on the hard coating film.

### Solution to Problem

As a result of intensive study to solve the above problems, the present inventors focused on features (peak area ratios) on the infrared spectrum of the resin composition contained in the hard coating layer, and found that the features on the infrared spectrum contribute to the improvement of the adhesion of the hard coating layer and adhesion to a laminated film formed on the hard coating film. Then, the present inventors found that by using a hard coating layer having the features on the infrared spectrum, a hard coating film having excellent optical characteristics and adhesion of a hard coating layer, and further having adhesion to a laminated film formed on the hard coating film can be obtained. Thus, the present invention has been completed.

That is, the present invention has the following configurations.

### (First Invention)

A hard coating film comprising a hard coating layer containing an ionizing radiation curable resin composition provided on one or both surfaces of a base film, the hard coating film satisfying the following conditions (I), (II), and (III):
condition (I): the ionizing radiation curable resin composition comprising an acrylic resin containing a (meth)acryloyl group;
condition (II): a peak area ratio 1 ((A/B)×100) of 5% or more (provided that in infrared spectrum measurement of the ionizing radiation curable resin composition in an uncured state, a peak area appearing at 3250 to 3500 cm⁻¹ is defined as A, and a peak area appearing at 1650 to 1800 cm⁻¹ is defined as B); and condition (III): a peak area ratio 2 ((C/B)×100) of 30% or less (provided that in infrared spectrum measurement of the ionizing radiation curable resin composition in an uncured state, a peak area appearing at 1500 to 1580 cm⁻¹ is defined as C, and a peak area appearing at 1650 to 1800 cm⁻¹ is defined as B).

### (Second Invention)

The hard coating film according to the first invention, wherein the ionizing radiation curable resin composition comprises inorganic fine particles or organic fine particles.

### (Third Invention)

The hard coating film according to the second invention, wherein the ionizing radiation curable resin composition further satisfies the following condition (IV):
condition (IV): a peak area ratio 3 ((D/B)×100) of 40% or more (provided that in infrared spectrum measurement of the ionizing radiation curable resin composition in an uncured state, a peak area appearing at 1000 to 1120 cm⁻¹ is defined as D, and a peak area appearing at 1650 to 1800 cm⁻¹ is defined as B).

### (Fourth Invention)

The hard coating film according to any one of the first to third inventions, wherein the ionizing radiation curable resin composition further satisfies the following condition (V):
condition (V): a peak area ratio 4 ((E/B′)×100) of 20% or less (provided that in infrared spectrum measurement of the ionizing radiation curable resin composition after curing, a peak area appearing at 1370 to 1435 cm⁻¹ is defined as E, and a peak area appearing at 1650 to 1800 cm⁻¹ is defined as B′).

### (Fifth Invention)

The hard coating film according to any one of the first to fourth inventions, wherein a surface of the hard coating layer has an arithmetic average surface roughness (Ra) in the range of 0.5 nm to 15.0 nm.

### (Sixth Invention)

The hard coating film according to any one of the first to fifth inventions, wherein the hard coating layer has a film thickness of 0.5 μm to 12.0 μm.

### (Seventh Invention)

The hard coating film according to any one of the first to sixth inventions, wherein the hard coating layer has a surface free energy in the range of 17.0 mJ/m² to 55.0 mJ/m².

### (Eighth Invention)

The hard coating film according to any one of the first to seventh inventions, wherein the base film is any one selected from polyethylene terephthalate, cycloolefin, polyethylene naphthalate, polyimide, triacetyl cellulose, and a liquid crystal polymer.

### (Ninth Invention)

The hard coating film according to any one of the first to eighth inventions, wherein the hard coating film has a maximum thermal shrinkage of 1.8% or less before heat treatment, and a maximum thermal shrinkage of 1.5% or less after heat treatment at 200° C. for 10 minutes.

### Advantageous Effects of Invention

According to the present invention, it is possible to provide a hard coating film having excellent optical characteristics and adhesion of a hard coating layer, and further having adhesion to a laminated film formed on the hard coating film.

### DESCRIPTION OF EMBODIMENTS

Embodiments for carrying out the present invention will be described in detail below; however, the present invention is not limited to the following embodiments.

In the present specification, the phrase “xx to yy” means “xx or more and yy or less,” unless otherwise specified.

As in the first invention described above, the present invention is a hard coating film comprising a hard coating layer containing an ionizing radiation curable resin composition provided on one or both surfaces of a base film, the hard coating film satisfying the following conditions (I), (II), and (III):
condition (I): the ionizing radiation curable resin composition comprising an acrylic resin containing a (meth)acryloyl group;
condition (II): a peak area ratio 1 ((A/B)×100) of 5% or more (provided that in infrared spectrum measurement of the ionizing radiation curable resin composition in an uncured state, a peak area appearing at 3250 to 3500 cm⁻¹ is defined as A, and a peak area appearing at 1650 to 1800 cm⁻¹ is defined as B); and
condition (III): a peak area ratio 2 ((C/B)×100) of 30% or less (provided that in infrared spectrum measurement of the ionizing radiation curable resin composition in an uncured state, a peak area appearing at 1500 to 1580 cm⁻¹ is defined as C, and a peak area appearing at 1650 to 1800 cm⁻¹ is defined as B).

The configuration of the hard coating film of the present invention will be described in detail below.

### [Base Film]

First, the base film of the hard coating film of the present invention will be described.

In the present invention, the base film of the hard coating film is not particularly limited, and examples thereof include films or sheets of polyethylene terephthalate, polyimide, polyethylene, polypropylene, acrylic resin, polystyrene, triacetyl cellulose, or polyvinyl chloride. Of these, it is preferable to use polyethylene terephthalate, polyethylene naphthalate, cycloolefin, polyimide, triacetyl cellulose, and a liquid crystal polymer, all of which have excellent transparency, heat resistance, dimensional stability, and the like, and it is more preferable to use polyethylene terephthalate, which is inexpensive and readily available, and cycloolefin, which has excellent optical characteristics and low hygroscopicity.

Further, in the present invention, the thickness of the base film is suitably selected depending on the application for which the hard coating film is used; however, the thickness of the base film is preferably in the range of 10 μm to 300 μm, and more preferably in the range of 20 μm to 200 μm, from the viewpoint of mechanical strength, handling properties, and the like.

In the present invention, when the base film is used for hard coating films, for the purpose of preventing the deterioration of the coating film due to ultraviolet rays and preventing poor adhesion, a film obtained by forming a kneaded resin of a resin constituting the base film and an ultraviolet absorber into a film, or a film obtained by applying a paint prepared by mixing a thermoplastic or thermosetting resin and an ultraviolet absorber to one or both surfaces of the base film, may be used.

### [Hard Coating Layer]

Next, the hard coating layer will be described.

In the present invention, the hard coating layer contains an ionizing radiation curable resin composition. The hard coating layer is formed from a cured coating film of the ionizing radiation curable resin composition.

As the resin contained in the hard coating layer, it is particularly preferable to use an ionizing radiation curable resin composition, because surface hardness (pencil hardness and scratch resistance) can be imparted to the hard coating layer, the degree of crosslinking can be adjusted by the amount of UV exposure, and the surface hardness of the hard coating layer can be adjusted.

In the present invention, the ionizing radiation curable resin composition comprises an acrylic resin containing a (meth)acryloyl group (the above condition (I)).

The ionizing radiation curable resin composition used in the present invention is a transparent resin that is cured by irradiation with ultraviolet rays (hereinafter abbreviated as “UV”) or electron beams (hereinafter abbreviated as “EB”), preferably an acrylic resin containing a (meth)acryloyl group, and more preferably a urethane acrylate resin containing a (meth)acryloyl group.

As explained above, the present inventors focused on features (peak area ratios) on the infrared spectrum of the resin composition contained in the hard coating layer, and found that the features on the infrared spectrum contribute to the improvement of the adhesion of the hard coating layer and adhesion to a laminated film formed on the hard coating film.

That is, it is important for the ionizing radiation curable resin composition used in the present invention to satisfy that in the infrared spectrum measurement of the ionizing radiation curable resin composition in an uncured state, when a peak area (peak range area) appearing at 3250 to 3500 cm⁻¹ is defined as A, and a peak area (peak range area) appearing at 1650 to 1800 cm⁻¹ is defined as B, the peak area ratio 1 ((A/B)×100) is 5% or more (the above condition (II)). The peak area ratio 1 is preferably 5% to 400%.

In the uncured ionizing radiation curable resin composition, the peak appearing at 1650 to 1800 cm⁻¹ of the infrared spectrum represents a carbon-oxygen stretching vibration peak derived from the (meth)acryloyl group. Moreover, the peak appearing at 3250 to 3500 cm⁻¹ of the infrared spectrum is assumed to represent a nitrogen-hydrogen bond derived from an amide group or an oxygen-hydrogen bond derived from a hydroxyl group.

That is, it is assumed that by having a peak appearing at 3250 to 3500 cm⁻¹ at a certain ratio or more with respect to the existing ratio of the (meth)acryloyl group, a balance is maintained between the adhesion of the hard coating layer to the substrate due to the (meth)acryloyl group and the peeling force exerted in a direction different from the interface with the base film as the hard coating layer is cured and shrunk within the layer, thereby improving the adhesion of the hard coating layer to the base film without the need to modify the anchor layer and the base film for various base films including cycloolefin films with less polar groups.

It is also important for the ionizing radiation curable resin composition used in the present invention to satisfy that in the infrared spectrum measurement of the ionizing radiation curable resin composition in an uncured state, when a peak area (peak range area) appearing at 1500 to 1580 cm⁻¹ is defined as C, and a peak area (peak range area) appearing at 1650 to 1800 cm⁻¹ is defined as B, the peak area ratio 2 ((C/B)×100) is 30% or less (the above condition (III)). The peak area ratio 2 is preferably 25% or less.

In the uncured ionizing radiation curable resin composition, it is assumed that the peak appearing at 1500 to 1580 cm⁻¹ of the infrared spectrum represents a nitrogen-hydrogen bond derived from an amide group, a carbon-hydrogen bond derived from a phenyl ring, or a nitrogen-nitrogen double bond derived from an azo group. Further, as described above, the peak appearing at 1650 to 1800 cm⁻¹ of the infrared spectrum represents a carbon-oxygen stretching vibration peak derived from the (meth)acryloyl group.

That is, it is assumed that the hardness of the hard coating layer against the base film can be further improved by having a peak appearing at 1500 to 1580 cm⁻¹ at a certain ratio or less with respect to the existing ratio of the (meth)acryloyl group.

It is also preferable for the ionizing radiation curable resin composition used in the present invention to further satisfy the following condition (IV).

That is, it is preferable to satisfy that in the infrared spectrum measurement of the ionizing radiation curable resin composition in an uncured state, when a peak area (peak range area) appearing at 1000 to 1120 cm⁻¹ is defined as D, and a peak area (peak range area) appearing at 1650 to 1800 cm⁻¹ is defined as B, the peak area ratio 3 ((D/B)×100) is 40% or more (condition (IV)). The peak area ratio 3 is further preferably 50% to 400%.

As described later, the ionizing radiation curable resin composition used in the present invention may further contain inorganic fine particles or organic fine particles.

In this case, it is assumed that in the uncured ionizing radiation curable resin, the peak appearing at 1000 to 1120 cm⁻¹ of the infrared spectrum represents a silicon-oxygen bond derived from the inorganic fine particles, such as nano silica, or the organic fine particles, such as silicone resin. Further, as described above, the peak appearing at 1650 to 1800 cm⁻¹ of the infrared spectrum represents a carbon-oxygen stretching vibration peak derived from the (meth)acryloyl group.

That is, since having a peak appearing at 1000 to 1120 cm⁻¹ at a certain ratio or more with respect to the existing ratio of the (meth)acryloyl group is synonymous with the presence of many silicon-oxygen bonds with high binding energy and excellent thermal stability in the hard coating layer, it is assumed to contribute to the improvement of the heat resistance of the hard coating layer. As a result, it is assumed that the deformation of the hard coating layer due to heat applied during formation of the laminated film on the hard coating film and in the post-process is mitigated, and that the adhesion of the hard coating layer and adhesion to the laminated film can be improved.

It is also preferable for the ionizing radiation curable resin composition used in the present invention to further satisfy the following condition (V).

That is, it is preferable to satisfy that in the infrared spectrum measurement of the ionizing radiation curable resin composition after curing, when a peak area (peak range area) appearing at 1370 to 1435 cm⁻¹ is defined as E, and a peak area (peak range area) appearing at 1650 to 1800 cm⁻¹ is defined as B′, the peak area ratio 4 ((E/B′)×100) is 20% or less (condition (V)). The peak area ratio 4 is particularly preferably 0.5% to 10%.

The peak appearing at 1370 to 1435 cm⁻¹ of the infrared spectrum represents a carbon-carbon double bond derived from the (meth)acryloyl group. Further, the peak appearing at 1650 to 1800 cm⁻¹ of the infrared spectrum represents a carbon-oxygen stretching vibration peak derived from the (meth)acryloyl group. Therefore, the peak area ratio 4 in the infrared spectrum measurement of the cured ionizing radiation curable resin composition represents the abundance ratio of carbonyl groups to (meth)acryloyl groups, and indicates the degree of hardening of the hard coating layer. That is, a larger peak area ratio 4 indicates that more unreacted (meth)acryloyl groups remain, and uncured components increase in the hard coating layer. As a result, it is assumed that the rigidity of the hard coating layer is reduced, and that the force that prevents the thermal deformation of the base film decreases. In the present invention, because the peak area ratio 4 is 20% or less, it is possible to suppress the reduction in the rigidity of the hard coating layer and the reduction in the force that prevents the thermal deformation of the base film. It is also assumed that the deformation of the hard coating layer and base film due to heat applied during formation of the laminated film on the hard coating film and in the post-process is mitigated, and that the adhesion of the hard coating layer and adhesion to the laminated film can be improved.

In addition to the acrylic resin containing a (meth)acryloyl group described above, the ionizing radiation curable resin composition may also be mixed with thermoplastic resins, such as polyethylene, polypropylene, polystyrene, polycarbonate, polyester, styrene-acrylic, and fibrin, and thermosetting resins, such as phenol resin, urea resin, unsaturated polyester, epoxy, and silicon resin, within the range that does not impair the effects of the present invention or the hardness and scratch resistance of the hard coating layer.

Usable examples of a photopolymerization initiator for the ionizing radiation curable resin composition include, but are not particularly limited to, commercially available acetophenones, such as Omnirad 651 and Omnirad 184 (trade names: produced by IMG), and benzophenones, such as Omnirad 500 (trade name: produced by IMG).

Moreover, the ionizing radiation curable resin composition used in the present invention may further contain inorganic fine particles or organic fine particles. By incorporating such inorganic fine particles or organic fine particles, the surface hardness (scratch resistance) and surface smoothness of the hard coating layer can be improved. Furthermore, as described above, it is possible to improve the adhesion to the laminated film.

In this case, the average particle diameter of the inorganic fine particles or organic fine particles is preferably in the range of 1 to 150 nm, and more preferably in the range of 10 to 100 nm. If the average particle diameter is less than 1 nm, it is difficult to obtain sufficient surface hardness. In contrast, if the average particle diameter exceeds 150 nm, the gloss and transparency of the hard coating layer may be lowered, and the flexibility may also be lowered.

Preferred examples of the inorganic fine particles include silica, alumina, and the like. Further, preferred examples of the organic fine particles include silicone resin and the like. In the present invention, it is preferable to contain silica, which is inorganic fine particles with very high binding energy and excellent thermal stability.

In the present invention, the content of the inorganic fine particles or organic fine particles is preferably 1.0 to 60.0 parts by mass based on 100 parts by mass of the solid content of the ionizing radiation curable resin composition. If the content is less than 1.0 part by mass, it is difficult to obtain an effect of improving surface hardness (scratch resistance). In contrast, if the content exceeds 60.0 parts by mass, the flexibility decreases and the haze increases, which is not preferable.

### [Hard Coating Film]

The hard coating film of the present invention is a hard coating film in which a hard coating layer is formed on at least one surface of a base film using an ionizing radiation curable resin composition that satisfies the above conditions.

A leveling agent can be used in the hard coating layer for the purpose of improving the coating properties. Usable examples thereof include known leveling agents, such as fluorine leveling agents, acrylic leveling agents, siloxane leveling agents, and adducts or mixtures thereof. The mixing amount can be set in the range of 0.01 parts by mass to 7 parts by mass based on 100 parts by mass of the solid content of the resin in the hard coating layer. Moreover, in touch panel applications etc., when adhesiveness using an optical transparent resin OCR is required for the purpose of adhesion to cover glass (CG), transparent conductive members (TSP), liquid crystal modules (LCM), etc., of touch panel terminals, it is preferable to use an acrylic leveling agent or fluorine leveling agent having a high surface free energy (approximately 40 mJ/cm² or more).

As other additives to be added to the hard coating layer, defoamers, surface tension-adjusting agents, antifouling agents, antioxidants, antistatic agents, ultraviolet absorbers, light stabilizers, and the like may be mixed, as needed, as long as the effects of the present invention are not impaired.

The hard coating layer is formed by applying a paint prepared by dissolving or dispersing the ionizing radiation curable resin composition described above, a photopolymerization initiator, other additives, and the like in a suitable solvent to the base film described above, followed by drying. The solvent can be suitably selected according to the solubility of the resin to be mixed, and may be any solvent that can uniformly dissolve or disperse at least the solids (resin, photopolymerization initiator, and other additives). Examples of such solvents include aromatic solvents, such as toluene, xylene, and n-heptane; aliphatic solvents, such as cyclohexane, methylcyclohexane, and ethylcyclohexane; ester solvents, such as methyl acetate, ethyl acetate, propyl acetate, isopropyl acetate, butyl acetate, and methyl lactate; ketone solvents, such as acetone, methyl ethyl ketone, methyl isobutyl ketone, and cyclohexanone; alcohol solvents, such as methanol, ethanol, isopropyl alcohol, and n-propyl alcohol; and other known organic solvents. These solvents can be used singly or in combination of two or more.

The coating method of the hard coating layer is not particularly limited: however, the hard coating layer is applied by a known coating method, such as gravure coating, micro-gravure coating, fountain bar coating, slide die coating, slot die coating, spin coating, a screen printing method, or a spray coating method, and then dried generally at a temperature of about 50 to 120° C.

In the present invention, a hard coating layer paint containing the ionizing radiation curable resin composition and the like is applied to a base film and dried, followed by irradiation with ionizing radiation (e.g., UV or EB) to induce photopolymerization, whereby a cured coating film (hard coating layer) having excellent hardness can be obtained. In particular, the hard coating layer preferably has a pencil hardness of 3B to 3H, as defined in JIS K5600 May 4. The exposure dose of ionizing radiation (e.g., UV or EB) on the dried coating film may be an exposure dose required to impart sufficient hardness to the hard coating layer, and can be suitably set depending on, for example, the type of ionizing radiation curable resin.

The film thickness of the hard coating layer is not particularly limited, but is preferably in the range of, for example, 0.5 μm to 12.0 μm, and more preferably in the range of 1.0 μm to 9.0 μm. If the film thickness is less than 0.5 μm, the hard coating layer cannot have sufficient rigidity, and it is difficult to prevent thermal deformation. If the film thickness exceeds 12.0 μm, the rigidity of the hard coating layer is significantly increased, and the flexibility and crack resistance of the hard coating layer are significantly reduced, which is not preferable. The film thickness of the hard coating layer can be measured by actual measurement with a micrometer.

Moreover, in the present invention, the arithmetic average surface roughness (Ra) of the hard coating layer surface is preferably in the range of 0.5 nm to 15.0 nm, and more preferably in the range of 1.0 nm to 12.0 nm.

The arithmetic average surface roughness (Ra) of the hard coating layer surface within the above range improves not only hardness but also adhesion to the laminated film formed on the hard coating film.

If the arithmetic average surface roughness (Ra) of the hard coating layer surface is less than 0.5 nm, the adhesion to the laminated film is reduced. If the arithmetic average surface roughness (Ra) is larger than 15.0 nm, the haze increases.

The arithmetic average surface roughness (Ra) mentioned above is a value that is defined by JIS B 0031 (1994)/JIS B 0061 (1994) Annex, and that is obtained by averaging absolute deviation from the average line of the roughness curve at a certain reference length; that is, it refers to the average value of unevenness when the roughness curve portion below the average line is folded back to the positive value side. The specific evaluation method (measurement method) of the arithmetic average surface roughness (Ra) in the present invention will be described later.

The arithmetic average surface roughness (Ra) of the hard coating layer surface can be adjusted, for example, by adding inorganic or organic fine particles to the hard coating layer, or by changing the type of solvent of the hard coating layer paint, or the drying conditions during coating of the hard coating layer.

Moreover, in the present invention, the surface free energy of the hard coating layer is preferably in the range of 17.0 mJ/m² to 55.0 mJ/m², and more preferably 17.0 mJ/m² to 45.0 mJ/m².

The surface free energy mentioned herein is defined as the “free energy of the unit area of the surface,” and refers to the excess energy of the surface of the hard coating layer compared with the inside (bulk) of the layer. The larger the surface free energy of a solid, the more easily gas and fine particles are adsorbed, the more easily a liquid gets wet, and the more easily it adheres to other solids.

The surface free energy can be measured by analyzing the contact angles of water and hexadecane by the Kaelble-Uy method using a contact angle meter or the like. In the present invention, the surface free energy of the hard coating layer is specifically a value calculated from the contact angle of water and the contact angle of n-hexadecane by the Kaelble-Uy method using a fully automatic contact angle meter DM-701 produced by Kyowa Interface Science Co., Ltd., where the contact angle of water is obtained by dropping 2 μL of water (pure water) on the hard coating layer surface, and measuring the contact angle after 1 second, and the contact angle of n-hexadecane is obtained by dropping 2 μL of n-hexadecane on the hard coating layer surface, and measuring the contact angle after 1 second.

The surface free energy of the hard coating layer within the above range improves the adhesion to the laminated film formed on the hard coating film.

In the present invention, the surface free energy within the above range improves wettability, thereby contributing to the improvement of the adhesion to the laminated film.

If the surface free energy is less than 17.0 mJ/m², there is a problem that the adhesion to the laminated film is reduced. If the surface free energy is too large, there is a problem that dirt adheres more easily and scratch resistance is reduced. Therefore, the upper limit of the surface free energy is preferably 55.0 mJ/m² or less, and more preferably 45.0 mJ/m² or less.

The surface free energy of the hard coating layer can be adjusted, for example, by adding a leveling agent (type and amount of leveling agent, etc.) to the hard coating layer.

Annealing can be applied to the hard coating film. Annealing is a method for removing residual stress in the film by heat treatment. Annealing completely crystallizes and immobilizes the molecules and improves dimensional stability. Annealing is preferably performed at a high temperature for a short period of time, preferably about 40 minutes at most. It is assumed that the use of the thus-annealed hard coating film will relax the deformation of the hard coating film due to heat applied during formation of the laminated film on the hard coating film and in the post-process, thereby improving the adhesion to the laminated film.

Moreover, in the present invention, it is preferable for the thermal shrinkage that the maximum thermal shrinkage before heat treatment is 1.8% or less, and that the maximum thermal shrinkage after heat treatment at 200° C. for 10 minutes is 1.5% or less; it is more preferable that the maximum thermal shrinkage before heat treatment is 1.6% or less, and that the maximum thermal shrinkage after heat treatment is 1.3% or less; and it is even more preferable that the maximum thermal shrinkage after heat treatment is 1.0% or less.

If the thermal shrinkage is 1.9% or more, the deformation of the hard coating film due to heat applied during formation of the laminated film and in the post-process is increased, which causes a reduction in adhesion to the laminated film, cracks of the laminated film, misalignment, and warpage of the film substrate.

As explained in detail above, the present invention is a hard coating film that is provided with a hard coating layer containing an ionizing radiation curable resin composition on one or both surfaces of a base film, and that satisfies the conditions (I), (II), and (III) described above. According to the present invention, it is possible to provide a hard coating film having excellent optical characteristics and adhesion of a hard coating layer, and further having adhesion to a laminated film formed on the hard coating film.

In addition, it is more preferable that the hard coating film of the present invention satisfies the conditions (IV) and/or (V) described above.

### EXAMPLES

The present invention will be described in more detail below with reference to Examples; however, the present invention is not limited to the following Examples. Comparative Examples will also be described.

Unless otherwise specified, “parts” and “%” described below represent “parts by mass” and “mass %,” respectively.

### Example 1

### [Preparation of Hard Coating Layer-Forming Resin Composition (Hard Coating Layer Paint) 1]

A fluorine leveling agent was added to an ionizing radiation curable resin composition (containing 23% in total of urethane acrylate and acrylic ester, 15% of amorphous silica, and 2% of a photopolymerization initiator, and also containing 35% of propylene glycol monomethyl ether, 15% of methyl ethyl ketone, and 10% of toluene as solvents) so that the solid content ratio was 0.1%. The resultant was used as a main agent, and the solid content concentration was adjusted to 25% using a diluent (a diluent obtained by mixing 70% of 1-propanol and 30% of diacetone alcohol).

A hard coating layer-forming resin composition 1 used in this Example was prepared in the above manner.

### [Production of Hard Coating Film]

Using a base film containing polyethylene terephthalate as a main component (trade name: “Cosmoshine A4360,” thickness: 125 μm, produced by Toyobo Co., Ltd.) as a base film, the hard coating layer-forming resin composition 1 was applied to both surfaces of the base film using a bar coater, and dried with hot air in a drying furnace at 80° C. for 1 minute, thereby forming coating layers with a coating thickness of 3.0 μm (one surface). The coating thickness was the same for both surfaces. The coating thickness was measured using Thin-Film Analyzer F20 (trade name) (produced by FILMETRICS).

The coating layers were cured at a UV exposure dose of 157 mJ/cm² using a UV irradiation device set at a height of 60 mm from the coating surface to form hard coating layers on both surfaces of the base film, thereby obtaining a hard coating film of Example 1.

### Example 2

A hard coating film of Example 2 was produced in the same manner as in Example 1, except that the coating thickness (one surface) in Example 1 was changed to 6.0 μm.

### Example 3

### [Preparation of Hard Coating Layer-Forming Resin Composition (Hard Coating Layer Paint) 2]

An ionizing radiation curable resin composition (urethane acrylate “FA-3352-3” (solid content: 40%, produced by Nippon Kako Toryo Co., Ltd.)) was adjusted to a solid content concentration of 20% using a diluent (a diluent obtained by mixing 60% of ethyl acetate and 40% of propylene glycol monomethyl ether acetate).

A hard coating layer-forming resin composition 2 used in this Example was prepared in the above manner.

### [Production of Hard Coating Film]

A hard coating film of Example 3 was produced in the same manner as in Example 1, except that the hard coating layer-forming resin composition 2 was used.

### Example 4

A hard coating layer-forming resin composition 3 was prepared in the same manner as in Example 1, except that in the hard coating layer-forming resin composition of Example 2, the amount of fluorine leveling agent added was changed so that the solid content ratio was 0.3%. Then, a hard coating film of Example 4 was produced in the same manner as in Example 1, except that the hard coating layer-forming resin composition 3 was used.

### Example 5

After a hard coating film was produced in the same manner as in Example 1, the obtained hard coating film was annealed in a drying furnace at 200° C. for 10 minutes, thereby obtaining a hard coating film.

### Comparative Example 1

A hard coating layer-forming resin composition 4 was prepared in the same manner as in Example 1, except that in the hard coating layer-forming resin composition of Example 1, 15% of amorphous silica was excluded from the ionizing radiation curable resin composition. Then, a hard coating film of Comparative Example 1 was produced in the same manner as in Example 1, except that the hard coating layer-forming resin composition 4 was used.

### Comparative Example 2

An ionizing radiation curable resin composition (containing 95% of a silicone oligomer UV curable resin “KR-513” (solid content: 100%, produced by Shin-Etsu Chemical Co., Ltd.) and 5% of a photopolymerization initiator) was used as a main agent, and the solid content concentration was adjusted to 45% using a diluent (a diluent obtained by mixing 40% of 1-propanol and 60% of propyl acetate).

A hard coating layer-forming resin composition 5 was prepared in the above manner.

A hard coating film of Comparative Example 2 was produced in the same manner as in Example 1, except that the hard coating layer-forming resin composition 5 was used.

### Comparative Example 3

An ionizing radiation curable resin composition (containing 95% of a polyester acrylate UV curable resin “M7300K” (solid content: 100%, produced by Toagosei Co., Ltd.) and 5% of a photopolymerization initiator) was used as a main agent, and the solid content concentration was adjusted to 45% using a diluent (a diluent obtained by mixing 40% of 1-propanol and 60% of propyl acetate).

A hard coating layer-forming resin composition 6 was prepared in the above manner.

A hard coating film of Comparative Example 3 was produced in the same manner as in Example 1, except that the hard coating layer-forming resin composition 6 was used.

### <Evaluation Method>

The hard coating films obtained in the above Examples and Comparative Examples were evaluated using the following methods and criteria. The results were summarized in Tables 1, 2, and 3.

### (1) Peak Area and Peak Area Ratio of Ionizing Radiation Curable Resin Composition

Using an infrared spectrophotometer, the infrared spectrum (infrared absorption spectrum) was measured by the ATR method on the uncured ionizing radiation curable resin composition (the resin used in the hard coating layer). The infrared spectrophotometer used was FT-IR Spectrometer Spectrum 100 (produced by PerkinElmer Japan Co., Ltd.).

As the measurement method, a base film coated with the hard coating layer-forming resin composition was dried in a drying furnace at 80° C. for 3 hours, and then the coated surface was brought into contact with the measuring part (sensor part) of the infrared spectrophotometer in an environment at a temperature of 23° C. and a humidity of 50% to measure the infrared spectrum.

On the obtained spectral chart with wavenumber (cm⁻¹) on the horizontal axis and absorbance on the vertical axis, baselines were drawn at 3250 to 3500 cm⁻¹, 1650 to 1800 cm⁻¹, 1500 to 1580 cm⁻¹, and 1000 to 1120 cm⁻¹, the areas surrounded by these baselines and the spectral curve were each defined as peak areas A, B, C, and D, and the ratios ((A/B)×100), ((C/B)×100), and ((D/B)×100) were defined as peak area ratios 1, 2, and 3, respectively.

Further, using the above infrared spectrophotometer, the infrared spectrum (infrared absorption spectrum) was measured by the ATR method on the hard coating layer surface (the cured ionizing radiation curable resin composition) of the hard coating film. As the measurement method, the hard coating layer surface was brought into contact with the measuring part (sensor part) of the infrared spectrophotometer in an environment at a temperature of 23° C. and a humidity of 30% to measure the infrared spectrum.

On the obtained spectral chart with wavenumber (cm⁻¹) on the horizontal axis and absorbance on the vertical axis, baselines were drawn at 1370 to 1435 cm⁻¹ and 1650 to 1800 cm⁻¹, the areas surrounded by these baselines and the spectral curve were each defined as peak areas E and B′, and the ratio ((E/B″)×100) was defined as a peak area ratio 4.

The above results were summarized in Table 1.

### (2) Arithmetic Average Surface Roughness Ra (Surface Smoothness)

The arithmetic average surface roughness (Ra) of the hard coating layer surface was measured using a Nano 3D Optical Interferometer “VS 1800” produced by Hitachi High-Tech Corporation.

### (3) Surface Free Energy

Using a fully automatic contact angle meter DM-701 produced by Kyowa Interface Science Co., Ltd., 2 μL of water (pure water) is dropped on the hard coating layer surface, and the contact angle after 1 second is measured. Further, 2 L of n-hexadecane is dropped on the hard coating layer surface, and the contact angle after 1 second is measured. Using the contact angle of water and the contact angle of n-hexadecane measured as described above, the surface free energy of the hard coating layer was calculated by the Kaelble-Uy method.

### (4) Optical Characteristics (Transmission and Haze)

The measurements were performed according to JIS-K-7361-1 and JIS-K-7136 using a haze meter HM150 (produced by Murakami Color Research Laboratory Co., Ltd.).

### (5) Adhesion

The adhesion was evaluated by a cross-cut peel test according to JIS-K5600 May 6. Specifically, 100 cross-cuts of 1 mm² were made on each hard coating film using a cross-cut peel test jig under ordinary conditions (23° C., 50% RH). Adhesive tape No. 252 produced by Sekisui Chemical Co., Ltd. was attached thereto, pressed uniformly with a spatula, and peeled in the direction of 60 degrees, and the number of remaining hard coating layers was evaluated in three stages. Determination was made after crimping and peeling 5 times at the same location. The evaluation criteria are as follows.
O: 100 cross-cuts (no peeling)
Δ: 99 to 90 cross-cuts (slight peeling)
X: 89 to 0 cross-cuts (peeled)

### (6) Laminated Film Adhesion

Using a magnetron sputtering device MSP-40T (produced by Vacuum Device Inc.), a Cu-sputtered film with a film thickness of 100 nm was formed on each hard coating film.

The adhesion to the laminated film was evaluated by a cross-cut peel test according to JIS-K5600 May 6 in the same manner as above. Specifically, 100 cross-cuts of 1 mm² were made on the Cu-sputtered film formed on each hard coating film using a cross-cut peel test jig under ordinary conditions (23° C., 50% RH). Adhesive tape No. 252 produced by Sekisui Chemical Co., Ltd. was attached thereto, pressed uniformly with a spatula, and peeled in the direction of 60 degrees, and the number of remaining Cu-sputtered films was evaluated in three stages. Determination was made after crimping and peeling 5 times at the same location. The evaluation criteria are as follows.
O: 100 cross-cuts (no peeling)
Δ: 99 to 90 cross-cuts (slight peeling)
X: 89 to 0 cross-cuts (peeled)

The evaluation results regarding the surface smoothness, surface free energy, optical characteristics, adhesion, and laminated film adhesion were summarized in Table 2.

### (7) Thermal Shrinkage

The measurement was performed according to JIS-K-7133 using a digital compact measuring microscope (produced by OLYMPUS). Heat treatments were performed at 150° C. for 30 minutes and at 200° C. for 30 minutes. The thermal shrinkage was measured in the coating direction of the hard coating film (abbreviated as “MD”) and in the width direction perpendicular thereto (abbreviated as “TD”).

The evaluation results regarding the thermal shrinkage were shown in Table 3.

TABLE 1

| | Peak area ratio 1 | Peak area ratio 2 | Peak area ratio 3 | Peak area ratio 4 |
|---|---|---|---|---|
| | (A/B) × 100 | (C/B) × 100 ≤ | (D/B) × 100 | (E/B′) × 100 ≤ |
| | 5%≤ | 30% | 40%≤ | 20% |
| Example 1 | 7% | 5% | 93% | 5% |
| Example 2 | 7% | 5% | 92% | 5% |
| Example 3 | 19% | 20% | 119% | 6% |
| Example 4 | 7% | 6% | 89% | 5% |
| Comparative | 4% | 5% | 4% | 5% |
| Example 1 | | | | |
| Comparative | −1% | −1% | 195% | 12% |
| Example 2 | | | | |
| Comparative | 0% | 3% | 10% | 9% |
| Example 3 | | | | |

TABLE 2

| | Physical properties | | | | | |
|---|---|---|---|---|---|---|
| | Surface | | Optical | | | |
| | smoothness | Surface free | characteristics | | | Laminated |
| | Ra | energy | Transmission | Haze | | film |
| | nm | mJ/m² | % | % | Adhesion | adhesion |
| Example 1 | 1.3 | 25 | 91.4 | 0.9 | O | O |
| Example 2 | 1.3 | 20 | 91.0 | 0.8 | O | O |
| Example 3 | 10.8 | 36 | 91.7 | 0.7 | O | O |
| Example 4 | 1.3 | 16 | 91.5 | 0.8 | O | Δ |
| Comparative | 0.7 | 25 | 90.1 | 0.7 | Δ | Δ |
| Example 1 | | | | | | |
| Comparative | 1.0 | 32 | 91.7 | 0.4 | O | X |
| Example 2 | | | | | | |
| Comparative | 0.7 | 42 | 91.7 | 0.4 | O | X |
| Example 3 | | | | | | |

TABLE 3

| | | 150° C. × 30 min | | 200° C. × 30 min | |
|---|---|---|---|---|---|
| | Annealing | Thermal shrinkage (%) | | Thermal shrinkage (%) | |
| | conditions | MD | TD | MD | TD |
| Example 1 | None | 0.7 | 0.5 | 1.5 | 1.0 |
| Example 5 | 200° C. × | 0.0 | 0.0 | 0.1 | 0.1 |
| | 10 min | | | | |

As is clear from the results of Tables 1, 2, and 3, the Examples of the present invention, which satisfy the conditions (I), (II), and (III) of the present invention, can provide hard coating films having excellent optical characteristics and adhesion of hard coating layers, and further having excellent adhesion to laminated films formed on the hard coating films.

On the other hand, in the Comparative Examples, which do not satisfy any of the conditions (I), (II), and (III) of the present invention, a hard coating film that satisfies all of optical characteristics, adhesion of a hard coating layer, and adhesion to a laminated film formed on the hard coating film cannot be obtained. The Comparative Examples particularly have insufficient adhesion to the laminated films.

1. A hard coating film comprising a hard coating layer containing an ionizing radiation curable resin composition provided on one or both surfaces of a base film, the hard coating film satisfying the following conditions (I), (II), and (III):
condition (I): the ionizing radiation curable resin composition comprising an acrylic resin containing a (meth)acryloyl group;
condition (II): a peak area ratio 1 ((A/B)×100) of 5% or more (provided that in infrared spectrum measurement of the ionizing radiation curable resin composition in an uncured state, a peak area appearing at 3250 to 3500 cm⁻¹ is defined as A, and a peak area appearing at 1650 to 1800 cm⁻¹ is defined as B); and
condition (III): a peak area ratio 2 ((C/B)×100) of 30% or less (provided that in infrared spectrum measurement of the ionizing radiation curable resin composition in an uncured state, a peak area appearing at 1500 to 1580 cm⁻¹ is defined as C, and a peak area appearing at 1650 to 1800 cm⁻¹ is defined as B).

2. The hard coating film according to claim 1, wherein the ionizing radiation curable resin composition comprises inorganic fine particles or organic fine particles.

3. The hard coating film according to claim 2, wherein the ionizing radiation curable resin composition further satisfies the following condition (IV):
condition (IV): a peak area ratio 3 ((D/B)×100) of 40% or more (provided that in infrared spectrum measurement of the ionizing radiation curable resin composition in an uncured state, a peak area appearing at 1000 to 1120 cm⁻¹ is defined as D, and a peak area appearing at 1650 to 1800 cm⁻¹ is defined as B).

4. The hard coating film according to claim 1, wherein the ionizing radiation curable resin composition further satisfies the following condition (V):
condition (V): a peak area ratio 4 ((E/B′)×100) of 20% or less (provided that in infrared spectrum measurement of the ionizing radiation curable resin composition after curing, a peak area appearing at 1370 to 1435 cm⁻¹ is defined as E, and a peak area appearing at 1650 to 1800 cm⁻¹ is defined as B′).

5. The hard coating film according to claim 1, wherein a surface of the hard coating layer has an arithmetic average surface roughness (Ra) in the range of 0.5 nm to 15.0 nm.

6. The hard coating film according to claim 1, wherein the hard coating layer has a film thickness of 0.5 μm to 12.0 μm.

7. The hard coating film according to claim 1, wherein the hard coating layer has a surface free energy in the range of 17.0 mJ/m² to 55.0 mJ/m².

8. The hard coating film according to claim 1, wherein the base film is any one selected from polyethylene terephthalate, cycloolefin, polyethylene naphthalate, polyimide, triacetyl cellulose, and a liquid crystal polymer.

9. The hard coating film according to claim 1, wherein the hard coating film has a maximum thermal shrinkage of 1.8% or less before heat treatment, and a maximum thermal shrinkage of 1.5% or less after heat treatment at 200° C. for 10 minutes.

10. The hard coating film according to claim 2, wherein the ionizing radiation curable resin composition further satisfies the following condition (V):
condition (V): a peak area ratio 4 ((E/B′)×100) of 20% or less (provided that in infrared spectrum measurement of the ionizing radiation curable resin composition after curing, a peak area appearing at 1370 to 1435 cm⁻¹ is defined as E, and a peak area appearing at 1650 to 1800 cm⁻¹ is defined as B′).

11. The hard coating film according to claim 3, wherein the ionizing radiation curable resin composition further satisfies the following condition (V):
condition (V): a peak area ratio 4 ((E/B′)×100) of 20% or less (provided that in infrared spectrum measurement of the ionizing radiation curable resin composition after curing, a peak area appearing at 1370 to 1435 cm⁻¹ is defined as E, and a peak area appearing at 1650 to 1800 cm⁻¹ is defined as B′).

12. The hard coating film according to claim 2, wherein a surface of the hard coating layer has an arithmetic average surface roughness (Ra) in the range of 0.5 nm to 15.0 nm.

13. The hard coating film according to claim 3, wherein a surface of the hard coating layer has an arithmetic average surface roughness (Ra) in the range of 0.5 nm to 15.0 nm.

14. The hard coating film according to claim 4, wherein a surface of the hard coating layer has an arithmetic average surface roughness (Ra) in the range of 0.5 nm to 15.0 nm.

15. The hard coating film according to claim 2, wherein the hard coating layer has a film thickness of 0.5 μm to 12.0 μm.

16. The hard coating film according to claim 3, wherein the hard coating layer has a film thickness of 0.5 μm to 12.0 μm.

17. The hard coating film according to claim 4, wherein the hard coating layer has a film thickness of 0.5 μm to 12.0 μm.

18. The hard coating film according to claim 5, wherein the hard coating layer has a film thickness of 0.5 μm to 12.0 μm.

19. The hard coating film according to claim 2, wherein the base film is any one selected from polyethylene terephthalate, cycloolefin, polyethylene naphthalate, polyimide, triacetyl cellulose, and a liquid crystal polymer.

20. The hard coating film according to claim 3, wherein the base film is any one selected from polyethylene terephthalate, cycloolefin, polyethylene naphthalate, polyimide, triacetyl cellulose, and a liquid crystal polymer.
